(19) United States
(12) Patent Application Publication
(10) Pub. No.: US 2026/0213181 A1
(43) Pub. Date: Jul. 23, 2026

(54) PROCESSES TO REDUCE GAMMA-NiOOH IN BATTERY MATERIAL

(71) Applicant: BASF CORPORATION, Florham Park, NJ (US)

(72) Inventors: Xue LIU, Solon, OH (US); Dieter G. VON DEAK, Solon, OH (US); Tinoush DINN, Beachwood, OH (US); Martin Lawrence PANCHULA, Eastlake, OH (US); William C MAYS, Commerce Township, OH (US)

(73) Assignee: BASF CORPORATION, Florham Park, NJ (US)

(21) Appl. No.: 19/140,563

(22) PCT Filed: Dec. 27, 2023
(86) PCT No.: PCT/US2023/085952

§ 371 Date: Jun. 18, 2025

Related U.S. Application Data
(60) Provisional application No. 63/477,668, filed on Dec. 29, 2022.

(51) Int. Cl. H01M 4/525; C01G 53/42

(52) U.S. Cl. CPC H01M 4/525; C01G 53/42; C01P 2002/50; C01P 2002/72; C01P 2006/40

(57) ABSTRACT

Disclosed is a process for preparing a battery material including thermal treating an aqueous suspension including partially Delithiated Lithium Nickel Oxide (DLNO) to create a thermally treated suspension and contacting the thermally treated suspension with an aqueous medium including KOH, at a temperature between 20 degrees Celsius and 90 degrees Celsius to create a stabilized slurry containing solids of the battery material. A ratio of the weight of KOH in the aqueous medium to the weight of the DLNO in the thermally treated suspension may be between about 0.2 and about 0.03.

### TECHNICAL FIELD

The disclosure relates to processes for improving the quality of an intermediate product in battery material production. More specifically, the disclosure in some aspects relates to processes for treating a partially delithiated lithium nickel oxide (DLNO) material obtained from delithiation of a lithium nickel oxide (e.g. LiNiO₂) material to reduce the formation of γ-NiOOH in an acidic and/or caustic treated stabilized battery material.

### BACKGROUND

Lithium-ion batteries are increasingly used in essential applications such as powering electric vehicles, cellular telephones, and cameras. The formation of battery material for use in batteries typically involves two primary steps. First, a precursor can be formed by processes such as by co-precipitation reactions whereby transition metals are intermixed in the form of hydroxides or carbonates to form a precursor powder. This precursor can then be mixed with a lithium compound and calcined under high temperature to form an electrochemically active composition. During formation of the battery material according to traditional processes, the electrochemically active composition can be subjected to delithiation to remove the lithium while maintaining the crystal arrangement of the other elements in the resulting delithiated electrochemically active composition. This allows a battery material prepared from the delithiated electrochemically active composition to be incorporated into “charged” electrochemical cells as a cathode active material.

Prior processes for achieving this delithiation of the electrochemically active compositions suffered several drawbacks, such as undesirably high amounts of γ-NiOOH phase in the battery material. The γ-NiOOH phase may undesirably form on the surface of a delithiated electrochemically active composition upon contact with an alkaline solution typically found in electrolytes used in battery manufacture. As excessive γ-NiOOH phase reduces the battery quality, there is a need to develop techniques to reduce the formation of γ-NiOOH phase on delithiated electrochemically active composition.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

In one or more embodiments of the present disclosure is a process for preparing a battery material, the process including mixing LiₓNi_{z}O₂ with an aqueous medium to obtain an aqueous suspension comprising LiₓNi_{z}O₂; thermal treating the aqueous suspension including LixNizO2 for a first thermal treatment duration and at a first thermal treatment temperature, to create a thermally treated suspension; wherein x ranges from about 0.2 to about 0.2 and z ranges from about 0.1 to about 1; contacting the thermally treated suspension with an aqueous medium comprising an alkali, alkaline earth hydroxide, KOH or a combination thereof, at a second temperature between about 20 degrees Celsius and about 90 degrees Celsius to create a stabilized slurry containing solids of the battery material and filtrate liquid; wherein the ratio of the molar of hydroxide of the alkali, alkaline earth hydroxide, KOH, or combination thereof in the aqueous medium to the molar of the LiₓNi_{z}O₂ in the thermally treated suspension is between about 0.03 and about 0.2; and filtering the stabilized slurry to separate the solids from the filtrate liquid.

### BRIEF DESCRIPTION OF THE DRAWINGS

FIG. 1 shows a graph of an XRD analysis of various structures of nickel hydroxide.

FIG. 2 shows a diagram of an exemplary process of this disclosure.

### DETAILED DESCRIPTION

It is to be understood that the following disclosure describes several exemplary embodiments for implementing different features, structures, and/or functions of the invention. Exemplary embodiments of components, arrangement, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments can be used in any other exemplary embodiments, without departing from the scope of the disclosure.

The present disclosure is directed to processes for treating delithiated electrochemically active compositions to reduce the formation of γ-NiOOH. These delithiated electrochemically active compositions can include intermediate products of material suitable for use as battery material in an electrochemical cell, such as one or more cells within a primary or secondary battery. Provided are cost effective processes for treating delithiated electrochemically active compositions to reduce the formation of γ-NiOOH.

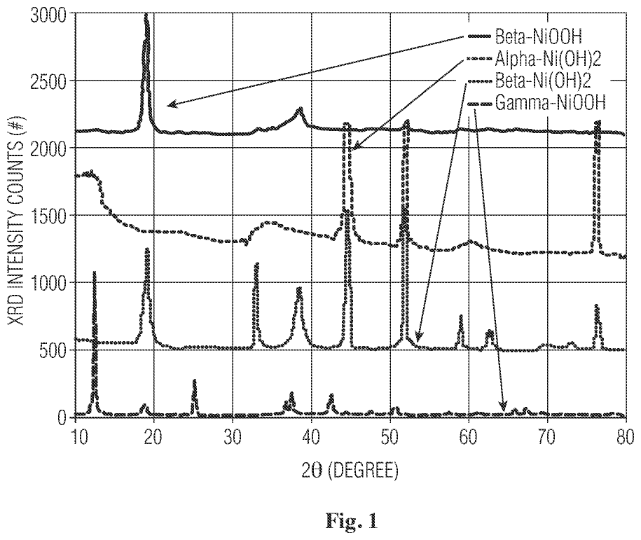

Gamma phase ( [symbol] ) is one of four nickel hydroxide structures. In Ni(II), aging of α-Ni(OH)₂ forms β-Ni(OH)₂. In Ni(III), aging of β-NiOOH forms [symbol] . When α-Ni(OH)₂ forms β-Ni(OH)₂, disorder at low 2θ may be observed. As shown in FIG. 1, when measured by X-ray diffraction (XRD), [symbol] can exhibit an XRD peak at 2θ of about 12.5°. The relative amount of [symbol] can be estimated by evaluating the XRD peak at 2θ of about 12.5° in comparison to peak heights from other phases or internal standards.

This disclosure provides processes for producing a battery material having a low amount of [symbol] . In one or more examples, the generation of battery material can begin with calcination of a lithium compound and a transition metal compound, rare earth element compound, or combinations thereof. In some examples, a lithium compound can include lithium hydroxide and the transition metal compound can be Ni(OH)₂, resulting in LNO (Lithium nickel oxide) as a material precursor of the battery material.

As used herein, the term “lithium compound” refers to a lithium containing composition in the form of a lithium hydroxide, lithium oxide, lithium carbonate, lithium nitrate, lithium sulfate, lithium acetate, lithium peroxide, lithium hydrogen carbonate, or a lithium halide.

The transition metal compound or rare earth compound can be selected from a metal, oxide, hydroxide, hydride, carbonate, hydroxy-carbonate, bicarbonate, nitrate, sulfate, acetate, halide, or combinations of one or more thereof.

As used herein, the term “calcination” refers to a thermal treatment in the presence of an oxidizing atmosphere so as to cause a chemical transformation of a material.

As used herein, the term “electrochemically active composition” refers to an active battery material precursor that has been subjected to calcination.

As used herein, the term “delithiated electrochemically active composition” refers to an electrochemically active composition that has been subjected to one or more delithiation processes. An example of a delithiated electrochemically active composition can include a delithiated LiNiO₂, which is also referred to herein as “DLNO”.

A “delithiation process” can include a process which decreases the lithium atomic percent (at %) on a metals basis. In one or more examples, the delithiation process can be a Ca/Na/Li hypochlorite delithiation process. One or more exemplary delithiation techniques are disclosed in WO2021183094 incorporated herein by reference.

Illustrative examples of electrochemically active compositions can include, but are not limited to chemistries based on LiNiMO where M is optional in the material and can be any transition metal, rare earth element, or combinations thereof.

A process for removing lithium from an electrochemically active composition can include providing an electrochemically active composition, combining the electrochemically active composition with a strong oxidizer or acid wash for a lithium removal time, and thereby forming a delithiated electrochemically active composition. Briefly, a delithiation process may include combining an electrochemically active composition defined by the formula of Li_{y}Ni_{z}MO₂ where M is optionally one or more metals, transition metals, rare earth metals or combinations thereof, with a strong oxidizer for a lithium removal time, wherein the lithium removal time is such that a Li/Ni at % ratio following the lithium removal time is less than the initial Li/Ni at % ratio, thereby forming a delithiated electrochemically active composition. A strong oxidizer may include one or more of a hypochlorite salt, chlorite salt, chlorate salt, perchlorate salt, hydrogen peroxide, chlorine, hypochlorous acid, or ozone.

The delithiated electrochemically active composition after being subjected to a delithiation process or processes can include those compositions falling under the formula Li_{y}Ni_{z}MO₂ where y is the atomic ratio of Li and is typically from 0 to 0.2, z is the atomic ratio of Ni and ranges from 0.1 to 1, and M can be an additive and may be one or more of Co, Mn, Al, Mg, Ti, Zr, Nb, Hf, V, Cr, Sn, Cu, Mo, W, Fe, Si, Zn, B, other transition metals, a rare earth element, or combinations thereof. In some aspects, Mis 1, 2, 3, 4, 5 or more of the foregoing list. In one or more embodiments, the Ni to M ratio can be from about 1:1 to about 100 to about 1, from about 200 to about 1, from about 300 to about 1, up to about 500 to about 1 or higher amounts of Ni. In one or more examples, the delithiated electrochemically active composition may not include M.

The atomic ratio of Li can be measured by any process known in the art. An example can include inductively coupled plasma atomic emission spectroscopy (ICP) or atomic absorption spectroscopy as described by J. R. Dean (Practical Inductively Coupled Plasma Spectroscopy, Chichester, England: Wiley, 2005, 65-87) and Welz and Sperling (Atomic Absorption Spectrometry, 3rd ed., Weinheim, Germany: Wiley VCH, 1999, 221-294). The chemical composition of compositions can be examined by a Varian Liberty 100 inductively-coupled plasma (ICP) system.

The delithiated electrochemically active composition can include Ni and one or more additives. In one or more examples, the delithiated electrochemically active composition can include Ni at an atomic percentage (at %) relative to the total the additive M in the electrochemically active composition of 10 at % or greater, optionally 20 at % or greater, optionally 30 at % or greater, optionally 40 at % or greater, optionally 50 at % or greater, optionally 60 at % or greater, optionally 70 at % or greater, optionally 80 at % or greater, optionally 90 at % or greater, optionally 95 at % or greater, optionally 96 at % or greater, optionally 97 at % or greater, optionally 98 at % or greater, optionally 99 at % or greater, optionally 100 at %. Optionally, the atomic percentage of Ni can be from 70 at % to 99 at % or greater. Optionally, the atomic percentage of Ni can be from 80 at % to 99 at % or greater. Optionally, the atomic percentage of Ni can be from 90 at % to 99 at % or greater. Optionally, Ni can be the only transition metal designed in or present in the material such that Ni can be present at substantially 100 at %. In one or more embodiments, the Ni to M ratio can be from about 1:1 to about 100 to about 1, from about 200 to about 1, from about 300 to about 1, up to about 500 to about 1 or higher amounts of Ni.

Optionally, a delithiated electrochemically active composition can include Ni and one or more other transition metals. If included, the one or more other transition metals (other than Ni) can each be individually present at 0 at % to 5 at %. Optionally, one or more other transition metals can each individually be present at 0.1 at % to 4.5 at %, optionally 0.5 at % to 4. at %. Optionally, 1, 2, 3, or more other transition metals other than Ni can be present in a delithiated electrochemically active composition.

A delithiated electrochemically active composition, such as DLNO, has a particle size. Particle size is defined as Dv50, which is a diameter of a particle such that about 50% of a sample's mass is smaller than and about 50% of a sample's mass is larger than the Dv50, assuming particle density is uniform and not a function of size. Optionally, a particle size can be 1-20 μm or any value or range therebetween. Optionally, a particle size can be from about 1 μm to about 15 μm, optionally from about 1-10 μm, optionally from about 1-7 μm, optionally from about 4-7 μm, optionally from about 4-6 μm. Particle size can be measured by techniques known in the art, for example, laser diffraction particle size analysis. Laser diffraction particle size analysis can measure particle size distributions by measuring the angular variation in intensity of light scattered as a laser beam passes through a dispersed particulate sample. Large particles scatter light at small angles relative to the laser beam and small particles scatter light at relatively large angles. The angular scattering intensity data can then be analyzed to calculate the size of the particles responsible for creating the scattering pattern, using the Mie theory of light scattering. The particle size can be reported as a volume equivalent sphere diameter.

Oftentimes, a delithiated electrochemically active composition that has been subjected to delithiation, such as DLNO, can be too chemically reactive for direct use as a battery material in battery cells. Therefore, the delithiated electrochemically active composition can be subjected to stabilization treatment.

Referring to LNO as an exemplary material precursor of such stabilization treatment, LNO can be treated with an aqueous oxidation process which causes the Ni(III) to partially oxidize to Ni(IV) and can effectively substantially delithiate the LNO, thereby forming DLNO (delithiated nickel oxide) as a first intermediate product. To stabilize the intermediate product for direct use in battery cells, the intermediate product can be partially stabilized (reduced) by exposing the intermediate product to alkali, alkaline earth hydroxide, KOH or a combination thereof, thereby stabilized delithiated nickel oxide can be formed (e.g., “KDLNO”). This KDLNO can be sufficiently stable and suitable for use as a battery material as well as other uses.

The sequence and approximate chemical formulas of the material in the various stages are shown below:
LNO—LiNi_{z}O₂ (Nickel oxidation state is from about 2.9 to 3.0)
DLNO—LiₓNi_{z}O₂ (Nickel oxidation state is from about 3.7 to 4.0)
KDLNO—K_{y}LiₓNi_{z}O₂ (Nickel oxidation state is from about 3.5 to 4.0);
wherein y can range from about 0 to 0.3, x can range from about 0 to 0.2, z can range from about 0.1 to 1, and x+y can range from about 0 to 0.5.

It can be advantageous to prepare the battery material in a manner that reduces the formation of γ-NiOOH in the battery material, such as by pre-treating the delithiated nickel oxide before conversion of the delithiated nickel oxide to potassium stabilized delithiated nickel oxide.

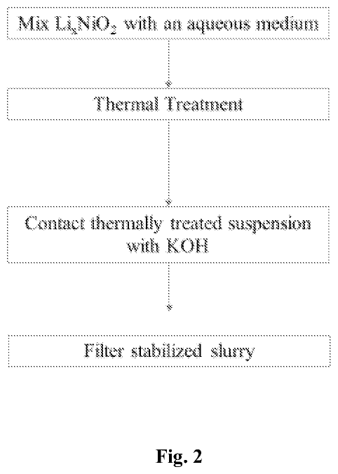

As shown by example in FIG. 2, a process for preparing a battery material can include a) mixing LiₓNi_{z}O₂ with an aqueous medium to obtain an aqueous suspension including LiₓNi_{z}O₂; b) thermal treating the aqueous suspension including LiₓNi_{z}O₂ for a first thermal treatment duration and at a first thermal treatment temperature, to create a thermally treated suspension; c) contacting the thermally treated suspension with an aqueous medium including alkali, alkaline earth hydroxide, KOH and/or a combination thereof, at a second temperature between 20 degrees Celsius and 90 degrees Celsius to create a stabilized slurry containing solids of the battery material and filtrate liquid; and d) filtering the stabilized slurry to separate the solids from the filtrate liquid.

In step a), the LiₓNi_{z}O₂ can be a delithiated nickel oxide, wherein x ranges from 0 to 0.2 and z ranges from 0.1 to 1. In one or more examples, x can be 0 or more, 0.05 or more, 0.1 or more, or 0.15 or more. In one or more examples, x can be 0.2 or less, 0.15 or less, 0.1 or less or 0.05 or less. In one or more examples, z can be 0.1 or more, 0.15 or more, 0.2 or more, 0.25 or more, or 0.3 or more. In one or more examples, z can be 1 or less, 0.9 or less, 0.8 or less, 0.7 or less, or 0.5 or less.

In the step a) of mixing LiₓNi_{z}O₂ with an aqueous medium to obtain an aqueous suspension including LiₓNi_{z}O₂, the aqueous medium can include water, deionized water, a dilute solution of alkali, alkaline earth hydroxide, KOH or a combination thereof or recycled filtrate liquid. In one or more examples, in step a), the aqueous medium can include an alkali, alkaline earth hydroxide, KOH or a combination thereof concentration of 1% by total of weight of the aqueous medium or less. In one or more examples, the aqueous medium can include an alkali, alkaline earth hydroxide, KOH or a combined concentration of 0.75% or less, 0.50% or less, 0.45% or less, 0.40% or less, 0.35% or less, 0.30% or less, 0.25% or less, or 0.20% or less. In one or more examples, the aqueous medium may be obtained from the recycled filtrate liquid obtained in step d). The alkali or alkaline earth hydroxide can be selected from NaOH, LiOH, KOH, Ca(OH)₂, or Mg(OH)₂, or a combination thereof.

In one or more examples, in a step b) of thermal treating an aqueous suspension including LiₓNi_{z}O₂, the first thermal treatment temperature can be a temperature ranging from about 50° C. to about 90° C. For example, the first thermal treatment temperature can be 50° C. or more, 55° C. or more, 60° C. or more, 65° C. or more, 70° C. or more, 75° C. or more or 80° C. or more. Additionally, the first thermal treatment temperature can be 90° C. or less, 85° C. or less, 80° C. or less, 75° C. or less, 70° C. or less, 65° C. or less, or 60° C. or less.

In the step b) of thermal treating an aqueous suspension including LiₓNi_{z}O₂, the first thermal treatment duration can be up to about 2 hours. For example, the first thermal treatment duration can be 30 minutes or more, 35 minutes or more, 40 minutes or more, 45 minutes or more, 50 minutes or more, 60 minutes or more, or 90 minutes or more. Additionally, the first thermal treatment duration can be 120 minutes or less, 115 minutes or less, 110 minutes or less, 100 minutes or less, 90 minutes or less, or 60 minutes or less.

In the step b) of thermal treating an aqueous suspension including LiₓNi_{z}O₂, the aqueous suspension can include 10 weight % to 60 weight % of LiₓNi_{z}O₂. For example, the aqueous suspension can include more than 10 weight %, more than 15 weight %, more than 20 weight %, more than 25 weight %, more than 30 weight %, or more than 35 weight % of LiₓNi_{z}O₂. Additionally, the aqueous suspension can include less than 60 weight %, less than 55 weight %, less than 50 weight %, less than 45 weight %, less than 40 weight %, or less than 35 weight % of LiₓNi_{z}O₂

After the step b) of thermal treating an aqueous suspension including LiₓNi_{z}O₂, the temperature of the thermally treated suspension can be changed before contacting the thermally treated suspension with the aqueous medium. In one or more examples, the temperature of the thermally treated suspension can be lowered before contacting the thermally treated suspension with the aqueous medium, such as by lowering the temperature by at least 5° C., at least 10° C., at least 15° C., at least 20° C., at least 25° C., at least 30° C., or at least 40° C.

In the step c) of contacting the thermally treated suspension with an aqueous medium, the thermally treated suspension can be contacted with an aqueous medium including alkali, alkaline earth hydroxide, KOH or a combination thereof to obtain a stabilized slurry containing solids of the battery material and filtrate liquid. In particular, the LiₓNi_{z}O₂ can be stabilized by contacting it with alkali, alkaline earth hydroxide, KOH or a combination thereof and converting the Liₓ Ni_{z}O₂ to K_{y}LiₓNi_{z}O₂. The resulting K_{y}LiₓNi_{z}O₂ is obtained as solids of the battery material in the stabilized slurry, also referred to herein as “KDLNO”.

In the step c) of contacting the thermally treated suspension with an aqueous medium, a ratio of the molar of hydroxide of the alkali, alkaline earth hydroxide, KOH, or combination thereof in the aqueous medium to the molar of the LiₓNi_{z}O₂ in the thermally treated suspension is between about 0.03 and about 0.2. For example, the ratio the molar of the hydroxide of the alkali, alkaline earth hydroxide, KOH or a combination thereof in the aqueous medium to the molar of the LiₓNi_{z}O₂ in the thermally treated suspension can be less than 0.1, less than 0.095, less than 0.09, less than 0.085, less than 0.08, less than 0.07, less than 0.06, or less than 0.05. Additionally, the ratio of the molar of the hydroxide of the alkali, alkaline earth hydroxide, KOH or a combination thereof in the aqueous medium to the molar of the LiₓNi_{z}O₂ in the thermally treated suspension can be more than 0.03, more than 0.035, more than 0.04, more than 0.045, more than 0.05, more than 0.06, more than 0.07, more than 0.08, more than 0.09, more than 0.10, more than 0.11, or more than 0.12. In one or more examples, a ratio of the molar of hydroxide of the alkali, alkaline earth hydroxide, KOH, or combination thereof in the aqueous medium to the molar of the LiₓNi_{z}O₂ in the thermally treated suspension is between about 0.06 and about 0.12.

At the beginning of the step c) of contacting the thermally treated suspension with an aqueous medium, the LiₓNi_{z}O₂ material can be present at 10 weight % to 95 weight % by total weight of the thermally treated suspension and aqueous medium. For example, the LiₓNi_{z}O₂ material can be present in an amount of at least 10 weight %, at least 15 weight %, at least 20 weight %, at least 25 weight %, at least 30 weight %, or at least 35 weight % by total weight of the thermally treated suspension and aqueous medium. Additionally, the LiₓNi_{z}O₂ material can be present in an amount of 95 weight % or less, 90 weight % or less, 85 weight % or less, 80 weight % or less, 75 weight % or less, 70 weight % or less, 65 weight % or less, 60 weight % or less, 55 weight % or less, or 50 weight % or less by total weight of the thermally treated suspension and aqueous medium.

The aqueous medium can include an alkali, alkaline earth hydroxide, KOH or a combination thereof at a concentration ranging from about up to about 1 weight % by total weight of the aqueous suspension. For example, the aqueous medium may include an alkali, alkaline earth hydroxide, KOH or a combination thereof at a concentration ranging from about up to about 1 weight %, 0.9 weight %, 0.75 weight %, 0.05 weight %, or 0.25 weight % by total weight of the aqueous suspension.

The step c) of contacting the thermally treated suspension with an aqueous medium may take place at a second temperature between 20° C. and 90° C. For example, the secondtemperature may be 20° C. or more, 25° C. or more, 30° C. or more, 35° C. or more, 40° C. or more, 50° C. or more or 60° C. or more. Additionally, the second temperature may be 90° C. or less, 85° C. or less, 80° C. or less, 75° C. or less, or 60° C. or less.

In the step c) of contacting the thermally treated suspension with an aqueous medium, a duration of the contacting can be up to about 5 hours. For example, the first thermal treatment duration can be 5 minutes or more, 10 minutes or more, 15 minutes or more, 30 minutes or more, 45 minutes or more, 60 minutes or more, or 90 minutes or more. Additionally, the first thermal treatment duration can be 300 minutes or less, 270 minutes or less, 240 minutes or less, 210 minutes or less, 180 minutes or less, or 140 minutes or less.

After, the step c) of contacting the thermally treated suspension with an aqueous medium to obtain a stabilized slurry containing solids of the battery material and filtrate liquid, the process can include step d) of filtering the stabilized slurry to separate the solids from the filtrate liquid.

Step d) can include filtering the stabilized slurry by a pressure or vacuum filtration process. In one or more examples, the step d) of filtering the stabilized slurry to separate the solids from the filtrate liquid can include filtering the stabilized slurry using a membrane filter press with a gauge feed pressure ranging from about-0.5 bar to about 7 bar, −0.25 bar to about 5 bar, 0 bar to about 3 bar, 0.5 bar to about 4 bar, 1 bar to about 3 bar or, or any gauge pressure therebetween.

The filtrate liquid obtained from step d) can include 0 to 5% weight % of KOH. The filtrate liquid obtained from step d) can include less than 5% weight % of KOH, less than 4.5% weight % of KOH, less than 4% weight % of KOH, less than 3% weight % of KOH, less than 2% weight % of KOH, or less than 1% weight % of KOH.

Optionally, the filtrate liquid may be recycled for use as a component of the aqueous medium or aqueous suspension.

The solids obtained from step d) of filtering the stabilized slurry to separate the solids from the filtrate liquid, may be obtained as a filtered cake. The filtered cake can be used as battery material without washing. Alternatively, the filtered cake may be washed with water, slightly acidified water, or slightly caustic water.

Optionally, the processes of this disclosure can further include thermal treating the solids separated from the filtrate liquid in step d) for a second thermal treatment duration and a second thermal treatment temperature.

The second thermal treatment duration can range from 30 minutes to 24 hours. For example, the second thermal treatment duration can be 30 minutes or more, 1 hour or more, 90 minutes or more, 2 hours or more, 3 hours or more or 4 hours or more. Additionally, the second thermal treatment duration can be 24 hours or less, 18 hours or less, 12 hours or less, or 6 hours or less.

The second thermal treatment temperature can range from 50° C. to 100° C. For example, the second thermal treatment temperature can be 50° C. or more, 55° C. or more, 60° C. or more, 65° C. or more, 70° C. or more, or 75° C. or more. Additionally, the temperature can be 100° C. or less, 95° C. or less, 90° C. or less, 85° C. or less, 80° C. or less, 750° C. or less, or 70° C. or less.

In one or more examples, a process for preparing a battery material can include a) mixing LiₓNi_{z}O₂ with an aqueous medium to obtain an aqueous suspension including LiₓNi_{z}O₂; b) contacting the aqueous suspension with an aqueous medium including KOH, at a second temperature between 20 degrees Celsius and 90 degrees Celsius to create a stabilized slurry containing solids of the battery material and filtrate liquid; and d) filtering the stabilized slurry to separate the solids from the filtrate liquid. The mixing, contacting and filtering steps may be performed as described above.

Advantageously, the amount of [symbol] in the solids obtained from processes of this disclosure can be low, thereby improving the quality of the KDLNO in use as a battery material. The amount of [symbol] in the solids can be measured by X-ray diffraction (XRD). In particular, the relative improvement in the amount of [symbol] in the stabilized product is estimated by determining a ratio of an X-ray diffraction (XRD) peak intensity at 2θ of about 12.5° and an XRD peak intensity at 2θ of about 37.3°.

In X-ray diffraction analysis, an X-ray beam rotates on one axis to diffract a statistical distribution of crystallites while data is collected by a single-axis goniometer. Suitable techniques for measuring the x-ray diffraction peak intensity include on a Cu-Kα powder x-ray diffraction analysis. In this application, KDLNO samples can be subjected to X-ray diffraction (XRD) to measure the peak intensity at 2θ of about 12.5°, 18.5° and 37.3° using Bruker D8 Advance XRD equipment. Using JADE v. 8.2 software, an automated background height determination without baseline smoothing can be generated and the 12.5, 18.5 and 37.3 degree maxima peak heights are determined.

The battery material after stabilization can have a ratio of a maximum intensity count (peak) of the solids at about 12.5 degrees to a maximum intensity count (peak) at about 37 degrees as measured on a Cu-Kα powder x-ray diffraction analysis of less than 1.0. For example, the ratio of a maximum intensity count of the solids at about 12.5 degrees to a maximum intensity count at about 37 degrees as measured on a Cu-Kα powder x-ray diffraction analysis can be less than 0.9, less than 0.8, less than 0.7, less than 0.6, less than 0.5, less than 0.4, less than 0.35, less than 0.3, less than 0.25, less than 0.2, or less than 0.1.

The battery material after stabilization can have a third x-ray diffraction peak intensity at a 2θ of about 18.5° and a ratio of the third peak intensity to the second peak intensity at 2θ of about 37.3° can range from 10:100 to 40:100, from 5:100 to 35:100; from 10:100 to 30:100, from 15:100 to 30:100, from 20:100 to 25:100.

The battery material obtained as solids in step d) can be represented by the formula K_{y}LiₓNi_{z}MO₂, wherein x ranges from 0 to 0.2, y ranges from 0 to 0.3, z ranges from 0.1 to 1, and x+y ranges from about 0 to 0.5, and Mis optional and may be one or more of Co, Mn, Al, Mg, Ti, Zr, Nb, Hf, V, Cr, Sn, Cu, Mo, W, Fe, Si, Zn, B, other transition metals, a rare earth element, or combinations thereof. In one or more embodiments, the Ni to M ratio can be from about 1:1 to about 100 to about 1, from about 200 to about 1, from about 300 to about 1, up to about 500 to about 1 or higher amounts of Ni.

In one or more examples, x can be 0 or more, 0.05 or more, 0.1 or more, or 0.15 or more. In one or more examples, x can be 0.2 or less, 0.15 or less, 0.1 or less or 0.05 or less. In one or more examples, y can be 0.05 or more, 0.1 or more, or 0.15 or more. In one or more examples, y can be 0.3 or less, 0.2 or less, 0.15 or less, or 0.1 or less. In one or more examples, z can be 0.1 or more, 0.2 or more, 0.3 or more, 0.4 or more or 0.5 or more. In one or more examples, z can be 1 or less, 0.9 or less, 0.8 or less or 0.7 or less.

In one or more examples, the battery material can include 0.5 weight % lithium or more by total weight of the battery material. In one or more examples, the battery material can include 0.5 weight % or more, 0.6 weight % or more, 0.75 weight % or more, 0.8 weight % or more, or 0.9 weight % or more lithium by total weight of the battery material. In one or more examples, the battery material can include 1.1 weight % lithium or less by total weight of the battery material. In one or more examples, the battery material can include 1.05 weight % or less, 1.0 weight % or less, 0.95 weight % or less, or 0.9 weight % or less lithium by total weight of the battery material.

In one or more examples, the battery material can include 50 weight % nickel or more by total weight of the battery material. In one or more examples, the battery material can include 55 weight % or more, 60 weight % or more, or 65 weight % or more nickel by total weight of the battery material. In one or more examples, the battery material can include 70 weight % nickel or less by total weight of the battery material. In one or more examples, the battery material can include 65 weight % or less, 60 weight % or less, or 55 weight % or less nickel by total weight of the battery material.

In one or more examples, the battery material can include 2 weight % potassium or more by total weight of the battery material. In one or more examples, the battery material can include 2.5 weight % or more, 3 weight % or more, or 4 weight % or more potassium by total weight of the battery material. In one or more examples, the battery material can include 6 weight % potassium or less by total weight of the battery material. In one or more examples, the battery material can include 5.5 weight % or less, 5 weight % or less, or 4 weight % or less potassium by total weight of the battery material.

The energy density of the battery material can be about 300 mAh/g to about 400 mAh/g. For example, the energy density of the battery material can be 310 mAh/g or greater, 315 mAh/g or greater, 320 mAh/g or greater, 325 mAh/g or greater, 330 mAh/g or greater, 335 mAh/g or greater, 340 mAh/g or greater, or 350 mAh/g or greater, or any combination thereof. For example, the energy density of the battery material can be 400 mAh/g or less, 395 mAh/g or greater, 390 mAh/g or less, 385 mAh/g or less, 380 mAh/g or less, 375 mAh/g or less, 370 mAh/g or less, or 365 mAh/g or less.

The energy density of the battery material can be measured by including the battery material in a battery and measuring the energy density of the resulting battery. The battery can have an anode including zinc (e.g., fine zinc), zinc alloy, and/or zinc alloy particles. The battery can further include an alkaline electrolyte solution, and a separator. The cathode can further include the battery material of this disclosure. The cathode can further include between 2 wt % and 35 wt % (e.g., between 5 wt % and 20 wt %, between 3 wt % and 8 wt %, between 10 wt % and 15 wt %) conductive additive. The conductive additive can include graphite, carbon black, acetylene black, partially graphitized carbon black, silver powder, gold powder, nickel powder, carbon fibers, carbon nanofibers, carbon nanotubes, and graphene. The electrolyte can include lithium hydroxide, sodium hydroxide, and/or potassium hydroxide. The separator can be capable of preventing soluble oxide species from diffusing from the cathode to the anode or of trapping soluble oxide species.

The battery material can be in the form of a filter cake having a tap density, after drying, ranging from 1.8 g/cm³ to 2.5 g/cm³. In one or more examples, the dried tap density of the battery material can be 1.8 g/cm³ or more, 1.9 g/cm³ or more, 2.0 g/cm³ or more, 2.05 g/cm³ or more, 2.1 g/cm³ or more, or 2.15 g/cm³ or more. The dried tap density of the battery material can be 2.5 g/cm³ or less, 2.4 g/cm³ or less, 2.3 g/cm³ or less, 2.25 g/cm³ or less, or 2.2 g/cm³ or less. Suitable techniques for measuring the dried tap density include 1) weighing a 250 mL graduate cylinder: M1; 2) filling KDLNO samples in the graduate cylinder below the 250 mL line; 3) weighing the graduate cylinder+KDLNO powders: M2, and the mass of the KDLNO powders is M3=M2−M1; 4) measuring the KDLNO volume in the graduate cylinder after 2500 taps in the Quantachrome auto tap analyzer: V1. The dried tap density is calculated by M3 divided by V1.

Various aspects of the present invention are illustrated by the following non limiting examples. The examples are for illustrative purposes and are not a limitation on any practice of the present invention. It will be understood that variations and modifications can be made without departing from the spirit and scope of the invention.

### EXAMPLES

In the following examples, a first intermediate product of a battery material obtained from a delithiation process may be treated by processes of this disclosure to reduce the amount of [symbol] .

### Example 1

Lithium nickel oxide (LNO) was delithiated by LiClO treatment at a molar ratio of 0.87 CIO/LNO. The obtained DLNO was subjected to a wash with DI-H₂O wash at 20° C. The DLNO was subjected to thermal treating at 70° C. and stabilized by treatment with KOH to obtain a KDLNO sample. The sample was dried overnight at 70° C. prior to testing for between 16-18 hrs.

The resulting KDLNO was subjected to X-ray diffraction (XRD) to measure the peak intensity at 2θ of about 12.5°, 18.5° and 37.3° using Rigaku Smartlab6 Advance XRD equipment. Using Rigako software, an automated background height determination without baseline smoothing was generated and the 12.5, 18.5 and 37.3 degree maxima peak heights were determined. Measured peak values were ratioed. Results of Examples 1-10 are presented in Table 1.

Comparative Examples 1-5 were prepared by a standard analytical stabilization procedure by reacting the same DLNO powder at the same KOH/DLNO molar ratio at room temperature without thermal treatment, and using DI water to form a mixture. Surprisingly, the resultant battery materials from these Comparative Examples had much higher gamma levels than battery materials processed using the stabilization procedures described in this disclosure. Examples 1-10 were prepared using the stabilization procedure described in this disclosure.

Comparative Example 1 used same DLNO powder as Example 1, but was prepared with a standard analytical stabilization procedure. As shown in Table 1, the KLDNO 12.5°/37° (%) was 38.1%. In contrast, with the stabilization procedure described in this disclosure, KLDNO 12.5°/37° (%) was reduced to 8.2% in Example 1 and 10.4% in Example 2.

Comparative Example 2 used the same DLNO powder as Example 3, but was prepared with a standard analytical stabilization procedure. As shown in Table 1, the KLDNO 12.5°/37° (%) of Comparative Example 2 was 31.9%. In contrast, with the stabilization procedure described in this disclosure, KLDNO 12.5°/37° (%) was reduced to 7.7% in Example 3 and 8.8% in Example 4.

Comparative Example 3 used the same DLNO powder as Example 5, but was prepared with a standard analytical stabilization procedure. As shown in Table 1, the KLDNO 12.5°/37° (%) of Comparative Example 3 was 30.1%. In contrast, with the stabilization procedure described in this disclosure, KLDNO 12.5°/37° (%) was reduced to 9.9% in Example 5 and 10.0% in Example 6.

Comparative Example 4 used the same DLNO powder as Example 7, but was prepared with a standard analytical stabilization procedure. As shown in Table 1, the KLDNO 12.5°/37° (%) of Comparative Example 4 was 87.3%. In contrast, with the stabilization procedure described in this disclosure, KLDNO 12.5°/37° (%) was reduced to 12.0% in Example 7 and 16.2% in Example 8.

Comparative Example 5 used the same DLNO powder as Example 9, but was prepared with a standard analytical stabilization procedure. As shown in Table 1, the KLDNO 12.5°/37° (%) of Comparative Example 5 was 118.1%. In contrast, with the stabilization procedure described in this disclosure, KLDNO 12.5°/37° (%) was reduced to 15.4% in Example 9 and 17.6% in Example 10.

TABLE 1

| | | | | KLDNO | KLDNO | |
|---|---|---|---|---|---|---|
| Example | ICP | ICP | ICP | 12.5°/37° | 18.5°/37° | Capacity |
| No. | Li % | Ni % | K % | (%) | (%) | (mAh/g) |
| Ex. 1 | 0.71 | 64.84 | 4.17 | 8.2 | 17.2 | 349.66 |
| Ex. 2 | 0.71 | 64.71 | 4.19 | 10.4 | 18.3 | 349.45 |
| Ex. 3 | 0.70 | 64.30 | 4.09 | 7.7 | 21.7 | 345.38 |
| Ex. 4 | 0.70 | 64.67 | 4.09 | 8.8 | 20.1 | 340.23 |
| Ex. 5 | 0.77 | 62.90 | 3.91 | 9.9 | 17.8 | 340.34 |
| Ex. 6 | 0.77 | 62.76 | 3.96 | 10.0 | 20.7 | 333.86 |
| Ex. 7 | 0.69 | 62.63 | 4.03 | 12.0 | 17.4 | 347.70 |
| Ex. 8 | 0.68 | 62.19 | 4.05 | 16.2 | 14.0 | 354.80 |
| Ex. 9 | 0.69 | 62.71 | 4.03 | 15.4 | 14.3 | 360.31 |
| Ex. 10 | 0.69 | 63.32 | 3.93 | 17.6 | 14.3 | 357.09 |
| Comp. Ex. 1 | 0.71 | 64.84 | 4.17 | 38.1 | — | 363 |
| Comp. Ex. 2 | 0.70 | 64.30 | 4.09 | 31.9 | — | 357 |
| Comp. Ex. 3 | 0.77 | 62.90 | 3.91 | 30.1 | — | 354 |
| Comp. Ex. 4 | 0.69 | 62.63 | 4.03 | 87.3 | — | 369 |
| Comp. Ex. 5 | 0.69 | 62.71 | 4.03 | 118.1 | — | 372 |

The present disclosure further relates to any one or more of the following numbered embodiments:

1. A process for preparing a battery material, the process including mixing LiₓNi_{z}O₂ with an aqueous medium to obtain an aqueous suspension comprising LiₓNi_{z}O₂, thermal treating the aqueous suspension comprising LiₓNi_{z}O₂ for a first thermal treatment duration and at a first thermal treatment temperature, to create a thermally treated suspension; wherein x ranges from about 0 to about 0.2 and z ranges from about 0.1 to about 1, contacting the thermally treated suspension with an aqueous medium including an alkali, alkaline earth hydroxide, KOH or a combination thereof, at a second temperature between 20 degrees Celsius and 90 degrees Celsius to create a stabilized slurry containing solids of the battery material and filtrate liquid; wherein the ratio of the molar of hydroxide of the alkali, alkaline earth hydroxide, KOH, or combination thereof in the aqueous medium to the molar of the LiₓNi_{z}O₂ in the thermally treated suspension is between about 0.03 and about 0.2; and filtering the stabilized slurry to separate the solids from the filtrate liquid.

2. The process of paragraph 1, wherein the aqueous suspension includes LiₓNi_{z}O₂ derived from a hypochlorite delithiation process.

3. The process of paragraphs 1 or 2, wherein the first thermal treatment duration is between about 30 minutes and about 120 minutes; and wherein the first thermal treatment temperature is between about 50 degrees Celsius and about 90 degrees Celsius.

4. The process according to any of paragraphs 1 to 3, wherein the first thermal treatment duration is about 40 to about 80 minutes and the first thermal treatment temperature is about 65 to about 85 degrees Celsius.

5. The process according to any of paragraphs 1 to 4, wherein the contacting the thermally treated suspension with an aqueous medium comprising an alkali, alkaline earth hydroxide, KOH or a combination thereof, at a second temperature is performed for about 5 minutes to about 5 hours.

6. The process according to any of paragraphs 1 to 5, wherein the temperature of the thermally treated suspension is changed before contacting the thermally treated suspension with the aqueous medium.

7. The process according to any of paragraphs 1 to 6, wherein the ratio of the molar of hydroxide of the alkali, alkaline earth hydroxide, KOH, or combination thereof in the aqueous medium to the molar of the LiₓNi_{z}O₂ in the thermally treated suspension is between about 0.06 and about 0.12.

8. The process according to any of paragraphs 1 to 7, wherein the filtrate liquid includes about 0% to about 5% weight % of KOH.

9. The process according to any of paragraphs 1 to 8, wherein one or more of the aqueous medium and the aqueous suspension includes recycled filtrate liquid.

10. The process according to any of paragraphs 1 to 9, wherein the aqueous suspension includes about 10 weight % to about 60 weight % of LiₓNi_{z}O₂.

11. The process according to any of paragraphs 1 to 10, wherein the solids have a ratio of a maximum intensity count of the solids at about 12.5 degrees to a maximum intensity count at about 37 degrees as measured by a Cu-Kα powder x-ray diffraction analysis of less than about 1.0.

12. The process according to any of paragraphs 1 to 11, wherein filtering the stabilized slurry includes a pressure or vacuum filtration process.

13. The process according to any of paragraphs 1 to 12, wherein the filtered cake can be used unwashed or washed with water, slightly acidified water, or slightly caustic water.

14. The process according to any of paragraphs 1 to 13, wherein the aqueous medium includes an alkali, alkaline earth hydroxide, KOH or a combination thereof at a concentration ranging from about up to about 1 weight % by total weight of the aqueous suspension.

15. according to any of paragraphs 1 to 14 process, wherein, at the beginning of the contacting step, the LiₓNi_{z}O₂ material is present at 10 weight % to 75 weight % by total weight of the thermally treated suspension with an aqueous medium.

16. The process according to any of paragraphs 1 to 15, wherein the process further includes thermal treating the solids separated from the filtrate liquid for a second thermal treatment duration and a second thermal treatment temperature.

17. The process according to any of paragraphs 1 to 16, wherein the second thermal treatment duration ranges from about 30 minutes to about 24 hours.

18. The process according to any of paragraph 1 to 17, wherein the second thermal treatment temperature ranges from about 50° C. minutes to about 100° C.

19. The process according to any of paragraph 1 to 18, wherein the battery material has an energy density ranging from about 300 mAh/g to about 400 mAh/g.

20. The process according to any of paragraph 1 to 19, wherein the battery material includes: from about 0.5 weight % to about 1.1 weight % lithium by total weight of the battery material, from about 50 weight % to 7 about 0 weight % nickel by total weight of the battery material, and from about 2 weight % to about 6 weight % potassium by total weight of the battery material.

21. The process according to any of paragraph 1 to 20, wherein the solid, after drying, has a tap density ranging from about 1.8 g/cm³ to about 2.5 g/cm³.

22. The process according to any of paragraph 1 to 21, wherein the LiₓNi_{z}O₂ further includes a concentration of one or more of Co, Mn, Al, Mg, Ti, Zr, Nb, Hf, V, Cr, Sn, Cu, Mo, W, Fe, Si, Zn, B, other transition metals, a rare earth element, or combinations thereof of about <5% by weight in total.

23. A process for preparing a battery material, the process including: mixing LiₓNi_{z}O₂ with an aqueous medium to obtain an aqueous suspension comprising LiₓNi_{z}O₂, wherein x ranges from about 0 to about 0.2 and z ranges from about 0.1 to about 1, contacting the aqueous suspension with including an alkali, alkaline earth hydroxide, KOH or a combination thereof, at a second temperature between 20 degrees Celsius and 90 degrees Celsius to create a stabilized slurry containing solids of the battery material and filtrate liquid; wherein the ratio of the molar of hydroxide of the alkali, alkaline earth hydroxide, KOH or a combination thereof in the aqueous medium to the molar of the LiₓNi_{z}O₂ in the thermally treated suspension is between about 0.03 and about 0.2; and filtering the stabilized slurry to separate the solids from the filtrate liquid. 24. The process of paragraph 23, wherein the aqueous suspension includes LixNizO2 derived from a hypochlorite delithiation process.

The forgoing description of particular aspect(s) is merely exemplary in nature and is in no way intended to limit the scope of the invention, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, and/or steps, these elements, components, regions, layers, and/or steps should not be limited by these terms. These terms are only used to distinguish one element, component, region, layer, or section from another element, component, region, layer, or section. Thus, “a first element,” “component,” “region,” “layer,” or “section” discussed above could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below. All numerical values are “about” or “approximately” the indicated values, and take into account experimental error and variations that would be expected by a person having ordinary skill in the art.

Unless otherwise defined, all terms (including technical and scientific terms) used herein have the same meaning as commonly understood by one of ordinary skill in the art to which this disclosure belongs.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. A process for preparing a battery material, the process comprising:
mixing LiₓNi_{z}O₂ with an aqueous medium to obtain an aqueous suspension comprising LiₓNi_{z}O₂;
thermal treating the aqueous suspension comprising LiₓNi_{z}O₂ for a first thermal treatment duration and at a first thermal treatment temperature, to create a thermally treated suspension,
wherein x ranges from about 0 to about 0.2 and z ranges from about 0.1 to about 1;
contacting the thermally treated suspension with an aqueous medium comprising an alkali hydroxide, alkaline earth hydroxide, KOH or a combination thereof, at a contacting temperature between about 20 degrees Celsius and about 90 degrees Celsius to create a stabilized slurry containing solids of the battery material and filtrate liquid;
wherein the molar ratio of the alkali hydroxide, alkaline earth hydroxide, KOH, or combination thereof in the aqueous medium to the LiₓNi_{z}O₂ in the thermally treated suspension is between about 0.03 and about 0.2; and
filtering the stabilized slurry to separate the solids from the filtrate liquid.

2. The process according to claim 1, wherein the aqueous suspension comprises LiₓNi_{z}O₂ derived from a hypochlorite delithiation process.

3. The process according to claim 1,
wherein the first thermal treatment duration is between about 30 minutes and about 120 minutes; and
wherein the first thermal treatment temperature is between about 50 degrees Celsius and about 90 degrees Celsius.

4. (canceled)

5. The process according to claim 1, wherein the contacting the thermally treated suspension with an aqueous medium comprising an alkali hydroxide, alkaline earth hydroxide, KOH or a combination thereof, at the contacting temperature is performed for about 5 minutes to about 5 hours.

6. (canceled)

7. The process according to claim 1, wherein the molar ratio of the alkali hydroxide, alkaline earth hydroxide, KOH, or combination thereof in the aqueous medium to the LiₓNi_{z}O₂ in the thermally treated suspension is between about 0.06 and about 0.12.

8. The process according to claim 1, wherein the filtrate liquid comprises about 0% to about 5% weight % of KOH.

9. The process according to claim 1, wherein one or more of the aqueous medium and the aqueous suspension comprises recycled filtrate liquid.

10. The process according to claim 1, wherein the aqueous suspension comprises about 10 weight % to about 60 weight % of LiₓNi_{z}O₂.

11. The process according to claim 1, wherein the solids have a ratio of a maximum intensity count at about 12.5 degrees to a maximum intensity count at about 37 degrees as measured by a Cu-Kα powder x-ray diffraction analysis of less than about 1.0.

12. (canceled)

13. (canceled)

14. The process according to claim 1, wherein the aqueous medium comprises an alkali hydroxide, alkaline earth hydroxide, KOH or a combination thereof at a concentration ranging from about up to about 1 weight % by total weight of the aqueous suspension.

15. The process according to claim 1, wherein, at the beginning of the contacting step, the LiₓNi_{z}O₂ material is present at 10 weight % to 75 weight % by total weight of the thermally treated suspension with an aqueous medium.

16. The process according to claim 1, wherein the process further comprises thermal treating the solids separated from the filtrate liquid for a second thermal treatment duration and a second thermal treatment temperature.

17. The process according to claim 16, wherein the second thermal treatment duration ranges from about 30 minutes to about 24 hours.

18. The process according to claim 16, wherein the second thermal treatment temperature ranges from about 50° C. to about 100° C.

19. The process according to claim 1, wherein the battery material has an energy density ranging from about 300 mAh/g to about 400 mAh/g.

20. The process according to claim 1, wherein the battery material comprises:
from about 0.5 weight % to about 1.1 weight % lithium by total weight of the battery material,
from about 50 weight % to about 70 weight % nickel by total weight of the battery material, and
from about 2 weight % to about 6 weight % potassium by total weight of the battery material.

21. The process according to claim 1, wherein the solid, after drying, has a tap density ranging from about 1.8 g/cm³ to about 2.5 g/cm³.

22. The process according to claim 1, wherein the LiₓNi_{z}O₂ further comprises a concentration of one or more of Co, Mn, Al, Mg, Ti, Zr, Nb, Hf, V, Cr, Sn, Cu, Mo, W, Fe, Si, Zn, B, other transition metals, a rare earth element, or combinations thereof of about <5% by weight in total.

23. A process for preparing a battery material, the process comprising:
mixing LiₓNi_{z}O₂ with an aqueous medium to obtain an aqueous suspension comprising LiₓNi_{z}O₂;
wherein x ranges from about 0 to about 0.2 and z ranges from about 0.1 to about 1,
contacting the aqueous suspension with an aqueous medium comprising alkali hydroxide, alkaline earth hydroxide, KOH or a combination thereof, at a contacting temperature between 20 degrees Celsius and 90 degrees Celsius to create a stabilized slurry containing solids of the battery material and filtrate liquid;
wherein the molar ratio of the alkali hydroxide, alkaline earth hydroxide, KOH or a combination thereof in the aqueous medium, to the LiₓNi_{z}O₂ in the thermally treated suspension, is between about 0.2 and about 0.03; and
filtering the stabilized slurry to separate the solids from the filtrate liquid.

24. The process according to claim 23, wherein the aqueous suspension comprises LiₓNi_{z}O₂ derived from a hypochlorite delithiation process.
